(19) United States
(12) Patent Application Publication
(10) Pub. No.: US 2024/0273088 A1
(43) Pub. Date: Aug. 15, 2024

(54) SYSTEM AND METHOD FOR BULK EXPORT OF RESOURCE DATA FOR VIEW PARAMETERS

(71) Applicant: RAKUTEN SYMPHONY SINGAPORE PTE. LTD., Singapore (SG)

(72) Inventors: Rohit GUPTA, Indore (IN); Yogesh CHOUHAN, Indore (IN)

(73) Assignee: RAKUTEN SYMPHONY SINGAPORE PTE. LTD., Singapore (SG)

(21) Appl. No.: 17/802,589

(22) PCT Filed: Jul. 27, 2022
(86) PCT No.: PCT/US2022/038438

§ 371 Date: Aug. 26, 2022

(51) Int. Cl. G06F 16/23; G06F 9/54

(52) U.S. Cl. CPC G06F 16/2386; G06F 9/54

(57) ABSTRACT

A system for bulk exporting resource data of parameters included in a view is provided. The system includes at least one processor configured to execute instructions to: receive a user request to bulk export resource data of the parameters for a plurality of instances of the view, based on the received user request, obtain view details for the view, wherein the view details comprise identifiers of the parameters included in the view and identifiers of one or more tables in which the resource data of the parameters are respectively stored, obtain, from the one or more tables and based on the view details, the resource data of the parameters for each of the plurality of instances of the view, and generate an export file including headers with the identifiers of the parameters, based on the obtained view details, and the obtained resource data of the parameters.

### BACKGROUND

Databases may be used to store data for a variety of applications. For example, in business environments, databases may be used to store and manage job information, employee information, site information, task information, and other related data for an application. The data may be input and/or viewed via different user interface views that store and/or fetch the data to/from the database tables.

A related art view building application may generate and configure different views for one or more other applications in an application platform (e.g., a cloud-based application platform for an enterprise or business). Each view corresponds to a screen, form, user interface, or page through which data may be input to respective fields (i.e., parameters) of the view and saved or stored in one or more databases or tables of the one or more other applications, and/or data may be fetched from the one or more databases or tables and output for display on respective fields of the view. The related art view building application allows a user to generate or modify a view by configuring the fields to be included in the view, from among previously-registered fields corresponding to backend resource fields (e.g., database table columns) of the one or more other applications.

When a user wants to input data into a view (e.g., form), the view is displayed on a user interface screen (e.g., a user interface of a corresponding application for which the view is created). The user can then manually input data into the respective fields of the displayed view, and save the view data into the backend table(s) that include columns corresponding to the respective view fields. This process can be repeated any number of times to create plural instances or records for a particular view. For example, where a task is to be performed multiple times on a particular job site or work order, a form (or view) may be filled out each time the task is performed and the corresponding input data may be stored in the backend table(s).

Where plural records or instances of data for a particular view are input and stored in a database or table(s), a user may desire to export this data in bulk so as to view the data as a whole, modify the data, etc. In the related art view building application, however, bulk export of resource data is not available. Further, because each view has different combinations of parameters mapped to different tables and table columns, a developer would have to write an application programming interface customized for each view in order to achieve a retrieval of resource data for the bulk export. Any changes to the fields in the view would therefore require changes in the APIs developed for the view to fetch the resource data for the respective fields. In other words, if the view is modified to include one or more additional fields, then a custom API must be developed to fetch the resource data for the view. This increases code complexity and results in multiple API creation and integration into a view. Further, any changes to views in the related art view building application are time consuming and inconvenient to a user, due to the additional API customization and development that is required.

### SUMMARY

According to one or more embodiments, systems and methods are provided for bulk exporting, for plural instances of a view, resource data of parameters included in the view, by executing a generic bulk exporting function that can be generically integrated into any view for fetching respective resource data, thereby eliminating the need for and development of custom APIs to fetch resource data of multiple instances of a view for the purpose of a bulk export.

According to embodiments, a system for bulk exporting resource data of parameters included in a view, includes: at least one memory storing instructions; and at least one processor configured to execute the instructions to: receive a user request to bulk export resource data of the parameters for a plurality of instances of the view, based on the received user request, obtain view details for the view, wherein the view details comprise identifiers of the parameters included in the view and identifiers of one or more tables in which the resource data of the parameters are respectively stored, obtain, from the one or more tables and based on the view details, the resource data of the parameters for each of the plurality of instances of the view, and generate an export file including headers with the identifiers of the parameters, based on the obtained view details, and the obtained resource data of the parameters.

The at least one processor may be further configured to execute the instructions to: make, by a first application, a get data API call for fetching the resource data of the parameters included in the plurality of instances of the view configured by the first application, wherein an input of the get data API call includes a view identifier corresponding to the view, and obtain, in response to the get data API call, the view details for the view; and the get data API may be generic across a plurality of views including a plurality of different parameters.

The at least one processor may be further configured to execute the instructions to: obtain, based on the identifiers the of one or more tables, information of a second application from resource information pre-registered in the first application, the resource information mapping applications to tables respectively associated with the applications; and send a request to the second application for resource data of at least one parameter, among the parameters, stored in at least one table associated with the second application, from among the one or more tables.

The at least one processor may be further configured to execute the instructions to: receive a first user input of one or more filters for selecting the view, the one or more filters including a common identifier for the plurality of instances of the view; based on the received first user input, output a list of instances of the view that satisfy the one or more filters; and receive a second user input for selecting the plurality of instances for which the resource data is to be bulk exported, from among the list of instances.

The at least one processor may be further configured to execute the instructions to execute the instructions to verify that the selected plurality of instances correspond to a same view, based on a view name identifier included in metadata for each of the plurality of instances.

The export file may be a spreadsheet in which the headers are included in a top row and rows below the top row respectively include the resource data of the parameters for the plurality of instances, with each row associated with a corresponding instance of the view.

The identifiers of the parameters may be distinguished by different colors corresponding to a plurality of different types of the parameters determined from the view details, the plurality of different types comprising read-only, mandatory, and optional.

The export file may include the obtained view details.

The at least one processor may be further configured to execute the instructions to update, based on the received user request, a status of plurality of instances of the view to complete.

According to embodiments, a method, performed by at least one processor, for bulk exporting resource data of parameters included in a view, includes: receiving a user request to bulk export resource data of the parameters for a plurality of instances of the view; based on the received user request, obtaining view details for the view, wherein the view details comprise identifiers of the parameters included in the view and identifiers of one or more tables in which the resource data of the parameters are respectively stored; obtaining, from the one or more tables and based on the view details, the resource data of the parameters for each of the plurality of instances of the view; and generating an export file including headers with the identifiers of the parameters, based on the obtained view details, and the obtained resource data of the parameters.

The obtaining the view details may include: making, by a first application, a get data API call for fetching the resource data of the parameters included in the plurality of instances of the view configured by the first application, wherein an input of the get data API call comprises a view identifier corresponding to the view, and obtaining, in response to the get data API call, the view details for the view; and the get data API may be generic across a plurality of views including a plurality of different parameters.

The obtaining the resource data may include: obtaining, based on the identifiers the of one or more tables, information of a second application from resource information pre-registered in the first application, the resource information mapping applications to tables respectively associated with the applications; and sending a request to the second application for resource data of at least one parameter, among the parameters, stored in at least one table associated with the second application, from among the one or more tables.

The receiving the user request may include: receiving a first user input of one or more filters for selecting the view, the one or more filters including a common identifier for the plurality of instances of the view; based on the received first user input, outputting a list of instances of the view that satisfy the one or more filters; and receiving a second user input for selecting the plurality of instances for which the resource data is to be bulk exported, from among the list of instances.

The method may further include verifying that the selected plurality of instances correspond to a same view, based on a view name identifier included in metadata for each of the plurality of instances.

The export file may be a spreadsheet in which the headers are included in a top row and rows below the top row respectively include the resource data of the parameters for the plurality of instances, with each row associated with a corresponding instance of the view.

The identifiers of the parameters may be distinguished by different colors corresponding to a plurality of different types of the parameters determined from the view details, the plurality of different types comprising read-only, mandatory, and optional.

The export file may include the obtained view details.

The method may further include updating, based on the received user request, a status of plurality of instances of the view to complete.

According to embodiments, a non-transitory computer-readable recording medium has recorded thereon instructions executable by at least one processor to perform a method for bulk exporting resource data of parameters included in a view, the method including: receiving a user request to bulk export resource data of the parameters for a plurality of instances of the view; based on the received user request, obtaining view details for the view, wherein the view details comprise identifiers of the parameters included in the view and identifiers of one or more tables in which the resource data of the parameters are respectively stored; obtaining, from the one or more tables and based on the view details, the resource data of the parameters for each of the plurality of instances of the view; and generating an export file including headers with the identifiers of the parameters, based on the obtained view details, and the obtained resource data of the parameters.

Additional aspects will be set forth in part in the description that follows and, in part, will be apparent from the description, or may be realized by practice of the presented embodiments of the disclosure.

### BRIEF DESCRIPTION OF THE DRAWINGS

Features, aspects and advantages of certain exemplary embodiments of the disclosure will be described below with reference to the accompanying drawings, in which like reference numerals denote like elements, and wherein:

FIG. 1 illustrates a flowchart of a method for bulk exporting resource data of parameters included in a view via a generic bulk export function, according to an embodiment;

FIG. 2 illustrates a flowchart of a method for receiving a user request to bulk export resource data of parameters for a plurality of instances of a view, according to an embodiment;

FIGS. 3A through 3C illustrate example user interface screens for requesting a bulk export of resource data, according to an embodiment;

FIG. 4 illustrates a flowchart of a method of obtaining view details for fetching resource data of a view, according to an embodiment;

FIG. 5 illustrates a flowchart of a method for requesting resource data based on view details of a view, according to an embodiment;

FIG. 6 illustrates a call flow diagram for fetching resource data of a current view according to an embodiment;

FIG. 7 illustrates an example export file to which resource data of a plurality of instances of a view is exported, according to an embodiment;

FIG. 8 is a diagram of an example environment in which systems and/or methods, described herein, may be implemented; and

FIG. 9 is a diagram of example components of a device according to an embodiment.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code. It is understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

As set forth above, bulk export of resource data is not available in related art view building or view displaying applications. Further, because each view (e.g., form) has different combinations of parameters (e.g., input fields) mapped to different tables and table columns in which the corresponding resource data (i.e., data input by a user to the parameters of an instance of the view) is stored, a developer would have to write an application programming interface (API) customized for each view in order to achieve a retrieval of resource data for the bulk export. Any changes to the fields in the view would therefore require changes in the APIs developed for the view to fetch the resource data for the respective fields. This increases code complexity and results in multiple API creation and integration into a view. Further, any changes to views in the related art view building application are time consuming and inconvenient to a user, due to the additional API customization and development that is required to synchronize the changed parameters with corresponding tables and the mechanisms by which data input to the view parameters are stored in the tables and/or later fetched for display.

Example embodiments of the present disclosure provide a method and system in which a generic bulk export function is incorporated into a resource data viewing application (e.g., the above-described related art view building application). The generic bulk export function in accordance with example embodiments utilizes a generic GET (or get data) application programming interface (API) (e.g., an API for making a GET request) to fetch resource data from various resources (e.g., columns of tables). As a result, the export function may be generically used to bulk export resource data for any of plural views and for any configuration or modification of a view, thereby eliminating the required development and attendant user inconvenience and time to configure customized APIs and mechanisms by which resource data is fetched and exported.

Example embodiments of the present disclosure provide a method and system that executes backend logic and makes a generic call to retrieve view details from a view configuration details table or database, and fetches resource data for a view based on the retrieved view details. As a result, different views may be configured and the same view may be modified with different parameters (or data fields) without requiring further API development/customization or hardcoding to achieve a working bulk export functionality, thereby reducing multiple API creation and integration into views and minimizing code complexity, development time, and user inconvenience.

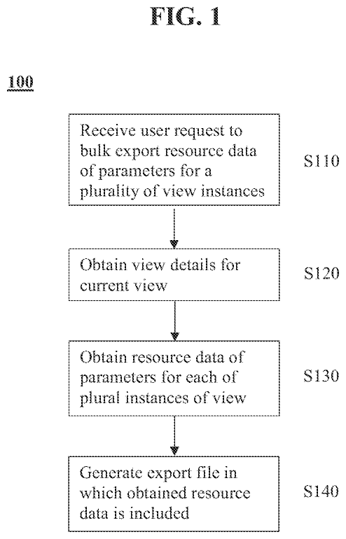

FIG. 1 illustrates a flowchart of a method 100 for bulk exporting resource data of parameters included in a view via a generic bulk export function, according to an embodiment. The method 100 of FIG. 1 may be performed by at least one processor executing instructions stored in at least one memory.

Referring to FIG. 1, at operation S110, a user request to bulk export resource data of parameters for a plurality of instances of a view is received. The user request may be received by a first application (e.g., view building application) that is an application for configuring (e.g., building) and viewing different views for one or more other applications (e.g., one or more other applications integrated with or into the first application), or may be received by the one or more other applications (e.g., on a screen for accessing views corresponding to the other application). The one or more other applications may be applications installed and deployed in an application platform, such as a cloud-based application platform for an enterprise or business. The one or more other applications and/or the first application may be deployed as containerized or microservices-based applications.

A view may correspond to a screen, form, user interface, or page through which data may be input to respective parameters (i.e., data fields such as Name, Gender, Age, Address, Equipment Information, etc.) of the view and stored in one or more databases or tables of (or associated with) the one or more other applications, and/or data may be fetched from the one or more databases or tables and output for display on respective parameters of the view. The first application allows a user to configure (e.g., generate or modify) a view by selecting the parameters to be included in the view, from among parameters previously registered in the first application and corresponding to backend resource fields (e.g., table columns) of the one or more other applications. For example, the previously-registered parameters may be listed or otherwise displayed for selection in a view configuration screen of the first application, and dragged and dropped onto a view being configured.

The user request to bulk export the resource data may be input via a user interface screen of the first application, or of a different application. The user request may be input to a selectable icon on a user interface screen in which a listing of previously-generated instances of views is provided. Each instance of a view may be an instance in which data is input to the parameters of the view (e.g., form). Thus, for a particular view, data may be input a plurality of different times and stored in one or more corresponding tables in which columns are respectively associated with the parameters.

In operation S120, view details for the current view (i.e., the view for which the user request to bulk export data is received) are obtained in response to or based on the received user request. The view details may be obtained from a database or table in which plural sets of view details are respectively mapped to corresponding view identifiers. The view details include identifiers of the parameters included in the view and identifiers of one or more tables in which the resource data of the parameters are respectively stored.

In operation S130, the resource data of the parameters for each of the plurality of instances of the current view is obtained from the one or more tables based on the obtained view details. That is, based on the parameters of the current view identified in the obtained view details, resource data (i.e., parameter values) of those parameters is obtained from the respective tables in which the resource data is stored. In one or more embodiments, as the tables are associated with or included in at least one other application (of the above-described one or more other applications), the request for the resource data may be sent to the at least one other application. By way of example, the request may be implemented by backend logic of the first application that submits an HTTP request to an API of or for each application associated with or including a table mapped to a parameter of the current view.

At operation S140, an export file is generated in which the obtained resource data is included or inserted. The export file may also include headers with identifiers of the parameters. For example, the first application (or the application through which the bulk export request is received) processes the resource data for inclusion in an export file. To this end, the first application (e.g., the backend API or logic, or get data API) may combine or merge the resource data, which is returned (e.g., by the get data API) in a single API response. Accordingly, the returned values are inserted into the export file. Here, the export file may be a spreadsheet, with a top row corresponding to the parameters and the subsequent rows each corresponding to a different instance of the view.

The export file may also include the obtained view details (e.g., in a separate tab of the spreadsheet, as metadata, as a hidden tab, etc.). At least some of the view details may be hidden, e.g., for security reasons. The export file may also include validations for the parameters. The validations may be recorded in and/or obtained from the view details. The validations may indicate a data type of each parameter (e.g., text, number, date, selectable option, drop-down selectable option, radio button selectable option, etc.), and/or a requirement of each parameter (e.g., mandatory, optional, read-only, etc.). Here, a mandatory requirement means that the parameter is required to have a data input when the view (e.g., form) is filled out by a user. Conversely, an optional requirement means that the parameter need not be filled out. The headers of each column in the export file may be color-coded based on the validations, e.g., a header cell or identifier for a parameter may be yellow for an optional parameter, grey for a read-only parameter, and blue for a mandatory parameter. The export file may also include fixed columns, which are added and included in any export file that is generated. For example, the fixed columns may correspond to information such as an identifier of each instance (i.e., in each row), a view name, a date/time in which the parameter data for a corresponding instance was input, etc. The identifier of each instance may be an index value (e.g., a work order number), a user-generated identifier, etc. The header(s) for the fixed column(s) may be color coded, e.g., green to identify or distinguish the column as a fixed column.

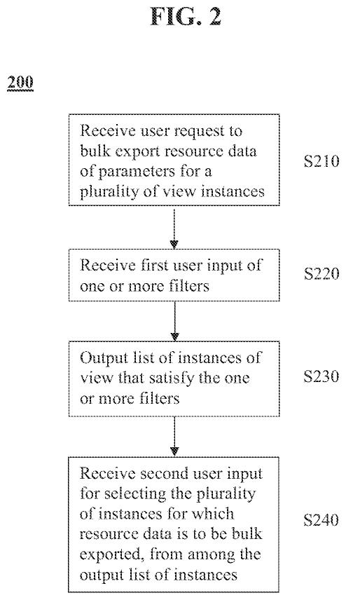

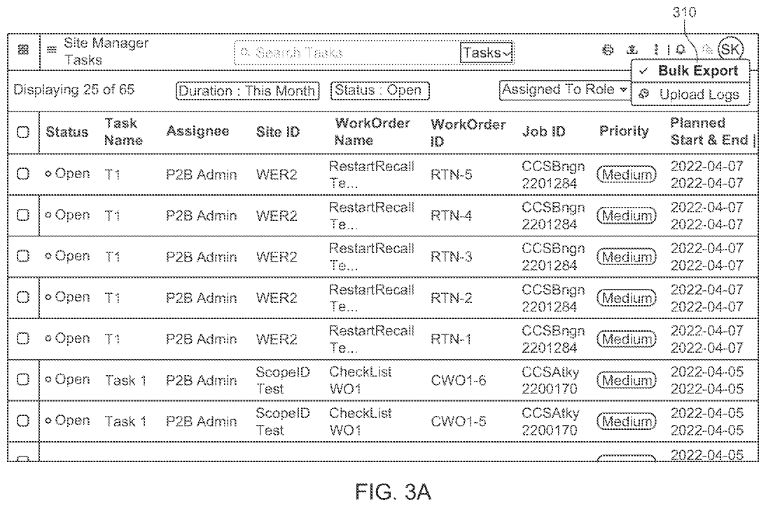

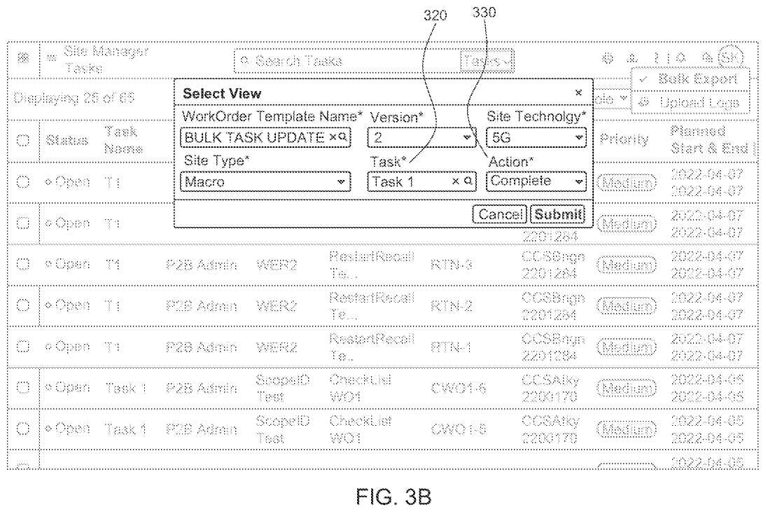

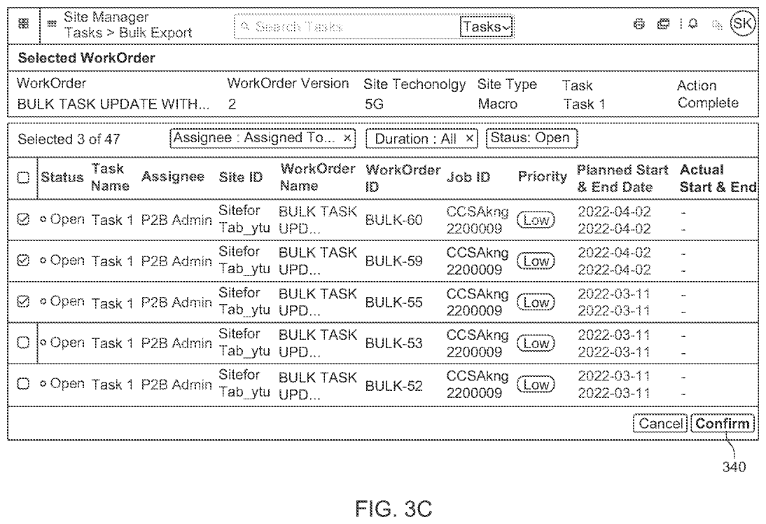

FIG. 2 illustrates a flowchart of a method 200 for receiving a user request to bulk export resource data of parameters for a plurality of instances of a view, according to an embodiment, and FIGS. 3A through 3C illustrate example user interface screens for requesting a bulk export of resource data, according to an embodiment. The method 200 of FIG. 2 may be performed by at least one processor executing instructions stored in at least one memory. For example, the method 200 of FIG. 2 may correspond to operation S110 of FIG. 1.

Referring to FIG. 2, at operation S210 a user request to bulk export resource data of parameters for a plurality of instances of a view is received. By way of example, the user request may be received on a user interface screen of a view building application, or a user interface screen of another application integrated with the view building application. For example, referring to FIG. 3A, the user request may be received to a bulk export option 310 presented on a screen of an application (e.g., site management application) in which instances of views (e.g., tasks) for that application are listed. In the example of FIG. 3A, there are listed five instances of a view labeled T1.

Referring back to FIG. 2, at operation S220, a first user input of one or more filters for selecting the view is received. Here, the one or more filters includes a common identifier for the plurality of instances of the view, e.g., an identifier of the view name or a sub-index (e.g., task identifier) for the view. For example, referring to FIG. 3B, based on the received user input to select the bulk export function (operation S210), a window or object may be displayed through which a user can input one or more filters for selecting the view for which to bulk export resource data. The filters include a field 320 for inputting a view name (or task name where the views correspond to tasks), and may further include various other fields for filtering down the instances of the view based on attributes or categories for the view. Additionally, the window or object may include an Action field 330 for selecting an action to perform on the selected instances of the view in addition to bulk export. For example, a status of the instances of the view may be changed in bulk to “Complete” (e.g., from “Open”) when executing the bulk export function.

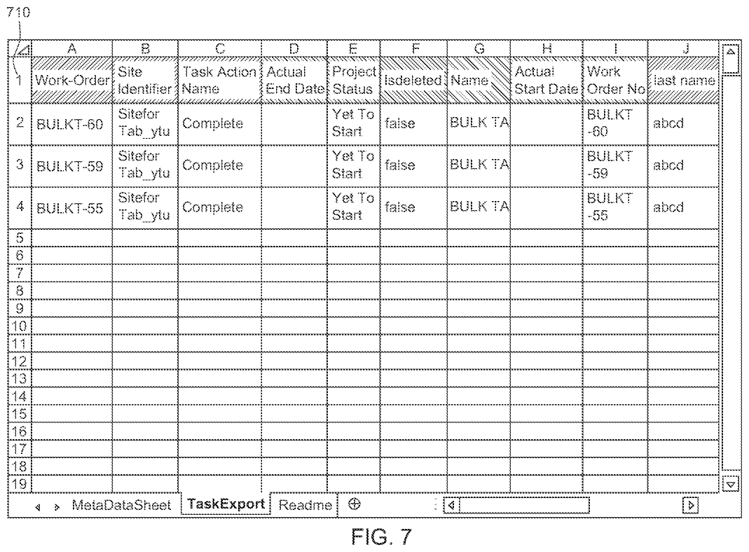

Referring back to FIG. 2, at operation S230, based on the received first user input, a list of instances of the view that satisfy the one or more filters is output. At operation S240, a second user input for selecting the plurality of instances for which the resource data is to be bulk exported, from among the list of instances, is received. For example, referring to FIG. 3C, a list of instances of a view corresponding to the identifier “Task 1” (input in the field 320 of the filter window of the previous screen of FIG. 3B) and satisfying the filters inputs of the previous screen is selected. In this example, a user selection of three of the listed instances is received for the bulk export. Upon selection of a confirm button 340, the resource data previously input to the view parameters of these three instances will be exported to an export file (as shown in FIG. 7). Further, in accordance with an embodiment, an additional action may be taken with respect to these instances. In the present example, a status of these views (e.g., tasks) will be changed to complete when executing the bulk export.

In accordance with an embodiment, the method may further include verifying that the selected plurality of instances correspond to a same view. In this case, the same view name (task name) may be assigned for different views having different combinations of parameters. The verification that the selected instances correspond to a same view may be performed by checking a view name identifier (unique to each view) included in metadata for each of the selected plurality of instances. If the view name identifier is different for two or more of the selected instances, then an error message may be output (e.g., a message such as “Only same view task can be exported”).

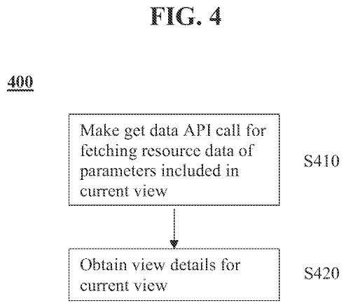

FIG. 4 illustrates a flowchart of a method 400 of obtaining view details for fetching resource data of a view, according to an embodiment. The method 400 of FIG. 4 may be performed by at least one processor executing instructions stored in at least one memory. For example, the method 400 of FIG. 4 may correspond to operation S120 of FIG. 1. In accordance with an example embodiment, resource data of a view may be fetched via a generic get data API.

Referring to FIG. 4, at operation S410, an application (e.g., the first application described above) makes or executes a get data API call for fetching resource data of parameters included in a view (i.e., current view). The current view may be a view identified or selected by a user input for requesting a bulk export of resource data of parameters included in a view. The get data API call may receive as an input at least a view identifier corresponding to the view, though it is understood that other embodiments are not limited thereto. For example, the get data API call may also receive as an input an application identifier that identifies an application for which the view is configured. The input to and execution of the get data API call may be implemented by execution logic included in a bulk export function executed in response to a user input requesting bulk export (e.g., execution logic of the first application or the application through which the bulk export request is made).

At operation S420, view details for the view are obtained in response to the get data API call. For example, the get data API call may request and receive view details from a database or table (e.g., JavaScript Object Notation (JSON) database or table), where said view details correspond to or are mapped to a view identifier. To this end, a view details storage (e.g., JSON database, table(s), resource file, etc.) may map views to corresponding parameters respectively included in the views as configured via the first application. That is, based on a view being built or modified with various parameters in the first application, the first application stores those parameters in association with an identifier of the view (e.g., view name, index value, etc.) in the view details storage. Thus, based on the view identifier input to the get data API call, the corresponding view details for the current view are obtained from the view details storage.

According to an embodiment, the view details include identifiers of the parameters included in the current view. The view details may further include identifiers of one or more tables in which the parameters are respectively included, i.e., as columns (though it is understood that, in one or more other embodiments, the mapping of parameters to tables may be separately stored in a different table or storage and retrieved via separate logic). TABLE 1 below illustrates an example of view details mapped to a current view in the view details storage and obtained based on the get data API call:

TABLE 1

| | |
|---|---|
| Table 1 | Parameter 1, Parameter 2 |
| Table 2 | Parameter 3, Parameter 4 |
| Table 3 | Parameter 5, Parameter 6 |

As can be seen in the example of TABLE 1 above, the current view includes six parameters from three different tables. The view details are retrieved based on the generic get data API call to which the view name of the current view is input. Because the view details storage (e.g., database, table(s), resource file, etc.) stores the various parameters configured or included in each view, custom APIs for fetching resource data for a particular view or modification of the view are not required. Instead, the generic get data API in accordance with example embodiments may be universally used to retrieve view details for each view from the view details storage.

For example, if the current view per the example of TABLE 1 is later modified to include an additional parameter from another table, e.g., Parameter 7 from Table 4 as shown in TABLE 2 below, then this update would be reflected in the view details for the current view as stored in the view details storage and would be retrieved by the generic get data API call without any API development or customizations:

TABLE 2

| | |
|---|---|
| Table 1 | Parameter 1, Parameter 2 |
| Table 2 | Parameter 3, Parameter 4 |
| Table 3 | Parameter 5, Parameter 6 |
| Table 4 | Parameter 7 |

Resource data of parameters included in a view may then be fetched for each of plural instances of the view, based on the obtained view details. As set forth above, a fetching resource data of parameters included in a view is executed using a get data API that is generic across a plurality of views (and modifications of a view) including a plurality of different parameters. Accordingly, customized logic or APIs do not need to be developed or deployed for each view or modification of a view when executing a bulk export function.

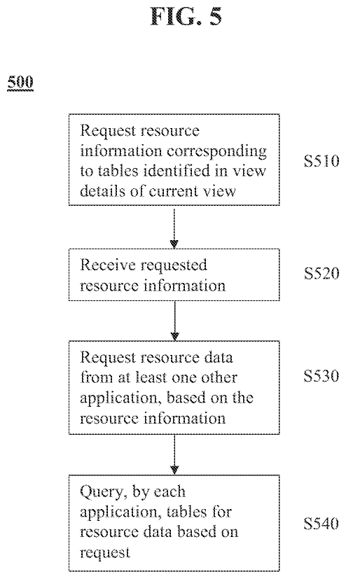

FIG. 5 illustrates a flowchart of a method 500 for requesting resource data based on view details of a view, according to an embodiment. The method 500 of FIG. 5 may be performed by at least one processor executing instructions stored in at least one memory. For example, the method 500 of FIG. 5 may correspond to operation S130 of FIG. 1.

Referring to FIG. 5, at operation S510, resource information corresponding to parameters and/or tables identified in the view detail information for a current view is requested from a resource information storage (e.g., database(s), table(s), resource file(s), etc.). The resource information identifies the application(s) including or associated with the table(s) in which the parameters of the current view are stored. To this end, the resource information storage maps applications to tables respectively associated with the applications. Thus, the request includes identification information of each table corresponding to a current view (i.e., each table including a parameter included in the current view). The identification information is obtained based on the view detail information for the current view. The request may be made by backend logic of the first application or the application through which the bulk export request is received, e.g., via a backend API call.

As set forth above, one or more other applications may be integrated into the first application such that views may be built for the other applications and/or such that views may be configured with parameters for inputting and/or viewing resource data stored in association with the other applications (e.g., stored in tables of or associated with the other applications). The tables included in (or associated with) each of the integrated applications may be previously registered in the first application, such as by including mapping information of the tables to their locations in the resource information storage (e.g., resource information table). Here, the locations may be the respective applications in which the tables are stored (or with which the tables are associated). For example, the resource information may be application or microservice information including at least one of an application name, a microservice name, a microservice path, etc. Thus, the resource information may be application or microservice information obtained for each table included or identified in the view details for a particular view. An example of the resource information obtained from the resource information storage based on the above TABLE 2 example of view details is provided in TABLE 3 below:

TABLE 3

| | |
|---|---|
| Table 1 | Microservice 1, path1 |
| Table 2 | Microservice 2, path2 |
| Table 3 | Microservice 3, path3 |
| Table 4 | Microservice 4, path4 |

Referring back to FIG. 5, in operation S520, resource information for the current view is received in response to the request. As set forth above, the resource information includes application information (e.g., at least one of application/microservice name, application/microservice path, etc.) of each application associated with or including a table(s) in which the parameters of the current view are stored.

At operation S530, based on the obtained resource information, a corresponding request for parameter values (or resource data) is made to each application or microservice that stores (or is associated with) the respective tables included or identified in the view details for the current view. The request may be made via a backend API (e.g., the same backend API through which the resource information table is queried) and/or logic of the first application. The request may be an HTTP request to an API of each individual application or microservice (e.g., a REST API). The request may include a query statement as a string input, where the query statement includes at least a table identifier or name (e.g., for each table, of the corresponding application/microservice, that is identified in the view details), a field or parameter identifier or name (e.g., for each parameter of the respective table(s) that is included in the view and identified in the view details), and a primary key value (e.g., for each table to be queried). The request may be for each instance of the current view. For example, a primary key value corresponding to each instance of the view for which data is to be exported per the bulk export may be included in the query or respective plurality of queries or requests.

At operation S540, each application or microservice that receives its corresponding request may then query its table(s) based on the request. For example, an API (e.g., REST API) that receives the request may execute a database query (e.g., native database query, SQL query, etc.) based on the request (e.g., the string input) for each table identified or included in the request, and may return corresponding resource data (i.e., values of the parameters as stored in the table(s)). The resource data is then returned to the first application (e.g., to the backend API and/or logic of the first application) or the application through which the bulk export is requested. The returned data may then be processed and included in the export file.

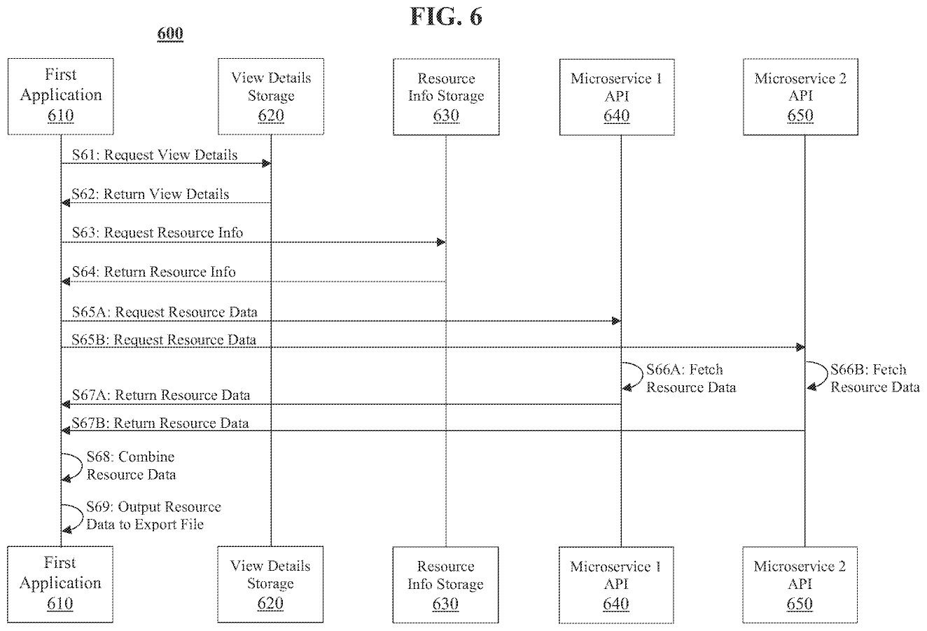

FIG. 6 illustrates a call flow diagram 600 for fetching resource data of a current view according to an embodiment. The operations shown in FIG. 6 may be performed by at least one processor executing instructions stored in at least one memory.

Referring to FIG. 6, at S61, a first application 610 (e.g., view builder or data viewing application) requests view details for a current view from a view details storage 620. For example, the first application 610 may submit a request to a generic get data API according to example embodiments, for obtaining resource data of parameters included in a view (i.e., current view) configured by the first application. The request may include at least an identifier of the current view. The view details storage 620 may include a database, a table, a resource file, etc., in which views are mapped to corresponding view details respectively for the views. The view details include information on the parameters respectively included in the views, and may further include information on the tables in which those parameters are stored or included (e.g., as columns).

At S62, the view details for the current view are returned in response to the request. That is, based on the identifier of the current view included in the request, the corresponding view details may be read from the view details storage 620 and returned to the first application 610.

At S63, the first application requests or queries resource information corresponding to the view details, from a resource information storage 630 (e.g., database(s), table(s), resource file(s), etc.). The resource information identifies the application(s) including or associated with the table(s) in which the parameters of the current view are stored. To this end, the resource information storage 330 maps applications to tables (or parameters) respectively associated with the applications. Thus, the request includes identification information of each table (or each parameter) corresponding to a current view (i.e., each table including a parameter included in the current view). The identification information is obtained based on the view detail information for the current view. The request may be made by backend logic of the first application 610, e.g., via a backend API call.

At S64, the resource information for the current view is returned to the first application 610 in response to the request. For example, the resource information may be microservice information including at least one of a microservice name, a microservice path, etc. Thus, the resource information may be microservice information obtained for each table (or each parameter) included or identified in the view details for a particular view.

At S65A and S65B, the first application 610 (or backend API, the get data API, etc.) sends requests to respective APIs 640 and 650 of each microservice included or identified in the resource information, in order to fetch corresponding resource data (i.e., values of the parameters included in the current view for each of plural instances of the current view) from the relevant tables (i.e., the tables in which parameters of the current view are stored). Each request may be an HTTP request to an API 640, 650 of each individual application or microservice (e.g., a REST API). The request may include a query statement as a string input, where the query statement includes at least a table identifier or name (e.g., for each table, of the corresponding application/microservice, that is identified in the view details), a field or parameter identifier or name (e.g., for each parameter of the respective table(s) that is included in the view and identified in the view details), and a primary key value (e.g., for each table to be queried). The request may include a mapping of parameters to tables. The request may include a request for each of plural instances of the view, e.g., with a primary key value corresponding to each instance.

At S66A and S66B, each microservice API 640, 650 fetches the requested resource data from the respective tables. For example, each API 640, 650 that receives the request may execute a database query (e.g., native database query, SQL query, etc.) based on the request (e.g., the string input) for each table identified or included in the request, and may return corresponding resource data (i.e., values of the parameters as stored in the table(s)).

At S67A and S67B, the resource data is returned by the microservice APIs 640, 650 to the first application 610 (e.g., to the backend API, the get data API, and/or logic of the first application 610).

At S68, the first application 610 (e.g., the backend API or logic, or get data API) combines or merges the resource data for each instance of the view, which may be returned (e.g., by the get data API) in a single API response. At S69, the first application 610 inserts the resource data in an export file.

The parameters included in the view may include data values (e.g., as input to the view via a text or character input, a drop down menu selection, a radio button selection, etc.).

FIG. 7 illustrates an example export file to which resource data of a plurality of instances of a view is exported, according to an embodiment.

Referring to FIG. 7, the export file may also include a first row of headers 710 with identifiers of the parameters of the selected view for the bulk export. These identifiers of the parameters may be obtained from the view details (e.g., view JSON), as described above. The headers of each column in the export file may be color-coded based on validations that may be also be obtained from the view details, e.g., a header cell or identifier for a parameter may be yellow for an optional parameter, grey for a read-only parameter, and blue for a mandatory parameter. The export file may also include the obtained view details in a separate tab (e.g., MetaDataSheet). Further, each row below the header row 710 respectively includes the resource data for the plurality of instances of the view selected for the bulk export, with each row associated with a corresponding instance.

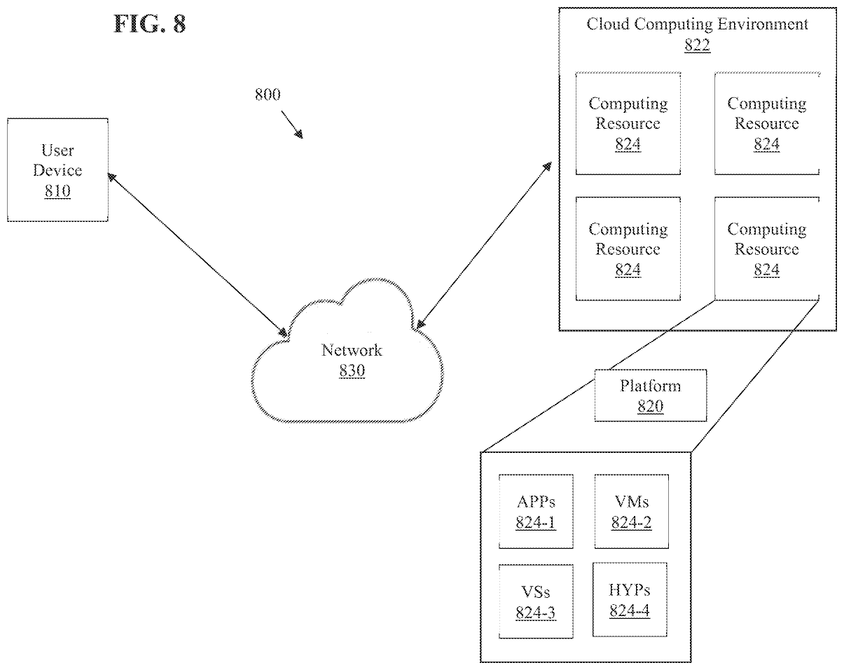

FIG. 8 is a diagram of an example environment 800 in which systems and/or methods, described herein, may be implemented. As shown in FIG. 8, environment 800 may include a user device 810, a platform 820, and a network 830. Devices of environment 800 may interconnect via wired connections, wireless connections, or a combination of wired and wireless connections. In embodiments, any of the functions and operations described with reference to FIGS. 1 through 7 above may be performed by any combination of elements illustrated in FIG. 8.

User device 810 includes one or more devices capable of receiving, generating, storing, processing, and/or providing information associated with platform 820. For example, user device 810 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device. In some implementations, user device 810 may receive information from and/or transmit information to platform 820.

Platform 820 includes one or more devices capable of receiving, generating, storing, processing, and/or providing information. In some implementations, platform 820 may include a cloud server or a group of cloud servers. In some implementations, platform 820 may be designed to be modular such that certain software components may be swapped in or out depending on a particular need. As such, platform 820 may be easily and/or quickly reconfigured for different uses.

In some implementations, as shown, platform 820 may be hosted in cloud computing environment 822. Notably, while implementations described herein describe platform 820 as being hosted in cloud computing environment 822, in some implementations, platform 820 may not be cloud-based (i.e., may be implemented outside of a cloud computing environment) or may be partially cloud-based.

Cloud computing environment 822 includes an environment that hosts platform 820. Cloud computing environment 822 may provide computation, software, data access, storage, etc., services that do not require end-user (e.g., user device 810) knowledge of a physical location and configuration of system(s) and/or device(s) that hosts platform 820. As shown, cloud computing environment 822 may include a group of computing resources 824 (referred to collectively as “computing resources 824” and individually as “computing resource 824”).

Computing resource 824 includes one or more personal computers, a cluster of computing devices, workstation computers, server devices, or other types of computation and/or communication devices. In some implementations, computing resource 824 may host platform 820. The cloud resources may include compute instances executing in computing resource 824, storage devices provided in computing resource 824, data transfer devices provided by computing resource 824, etc. In some implementations, computing resource 824 may communicate with other computing resources 824 via wired connections, wireless connections, or a combination of wired and wireless connections.

As further shown in FIG. 8, computing resource 824 includes a group of cloud resources, such as one or more applications (“APPs”) 824-1, one or more virtual machines (“VMs”) 824-2, virtualized storage (“VSs”) 824-3, one or more hypervisors (“HYPs”) 824-4, or the like.

Application 824-1 includes one or more software applications that may be provided to or accessed by user device 810. Application 824-1 may eliminate a need to install and execute the software applications on user device 810. For example, application 824-1 may include software associated with platform 820 and/or any other software capable of being provided via cloud computing environment 822. In some implementations, one application 824-1 may send/receive information to/from one or more other applications 824-1, via virtual machine 824-2.

Virtual machine 824-2 includes a software implementation of a machine (e.g., a computer) that executes programs like a physical machine. Virtual machine 824-2 may be either a system virtual machine or a process virtual machine, depending upon use and degree of correspondence to any real machine by virtual machine 824-2. A system virtual machine may provide a complete system platform that supports execution of a complete operating system (“OS”). A process virtual machine may execute a single program, and may support a single process. In some implementations, virtual machine 824-2 may execute on behalf of a user (e.g., user device 810), and may manage infrastructure of cloud computing environment 822, such as data management, synchronization, or long-duration data transfers.

Virtualized storage 824-3 includes one or more storage systems and/or one or more devices that use virtualization techniques within the storage systems or devices of computing resource 824. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 824-4 may provide hardware virtualization techniques that allow multiple operating systems (e.g., “guest operating systems”) to execute concurrently on a host computer, such as computing resource 824. Hypervisor 824-4 may present a virtual operating platform to the guest operating systems, and may manage the execution of the guest operating systems. Multiple instances of a variety of operating systems may share virtualized hardware resources.

Network 830 includes one or more wired and/or wireless networks. For example, network 830 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 8 are provided as an example. In practice, there may be additional devices and/or networks, fewer devices and/or networks, different devices and/or networks, or differently arranged devices and/or networks than those shown in FIG. 8. Furthermore, two or more devices shown in FIG. 8 may be implemented within a single device, or a single device shown in FIG. 8 may be implemented as multiple, distributed devices. Additionally, or alternatively, a set of devices (e.g., one or more devices) of environment 800 may perform one or more functions described as being performed by another set of devices of environment 800.

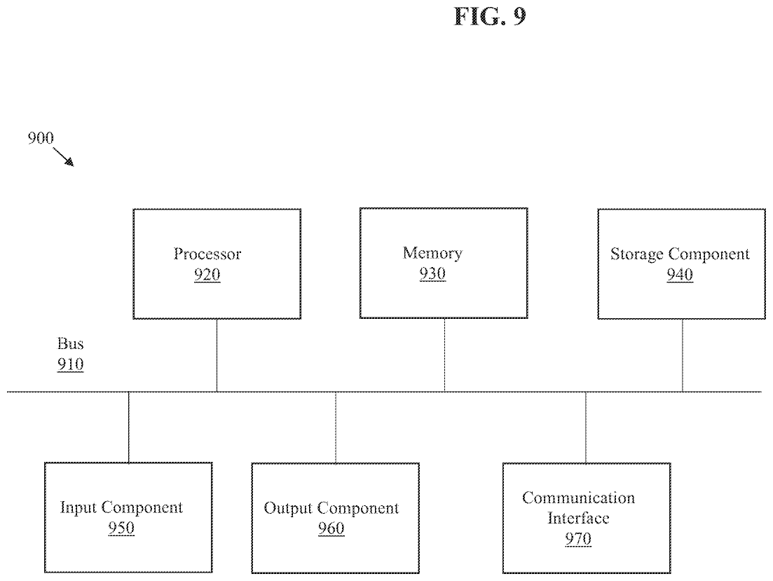

FIG. 9 is a diagram of example components of a device 900. Device 900 may correspond to user device 810 and/or platform 820. As shown in FIG. 9, device 900 may include a bus 910, a processor 920, a memory 930, a storage component 940, an input component 950, an output component 960, and a communication interface 970.

Bus 910 includes a component that permits communication among the components of device 900. Processor 920 may be implemented in hardware, firmware, or a combination of hardware and software. Processor 920 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 920 includes one or more processors capable of being programmed to perform a function. Memory 930 includes a random access memory (RAM), a read only memory (ROM), and/or another type of dynamic or static storage device (e.g., a flash memory, a magnetic memory, and/or an optical memory) that stores information and/or instructions for use by processor 920.

Storage component 940 stores information and/or software related to the operation and use of device 900. For example, storage component 940 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive. Input component 950 includes a component that permits device 900 to receive information, such as via user input (e.g., a touch screen display, a keyboard, a keypad, a mouse, a button, a switch, and/or a microphone). Additionally, or alternatively, input component 950 may include a sensor for sensing information (e.g., a global positioning system (GPS) component, an accelerometer, a gyroscope, and/or an actuator). Output component 960 includes a component that provides output information from device 900 (e.g., a display, a speaker, and/or one or more light-emitting diodes (LEDs)).

Communication interface 970 includes a transceiver-like component (e.g., a transceiver and/or a separate receiver and transmitter) that enables device 900 to communicate with other devices, such as via a wired connection, a wireless connection, or a combination of wired and wireless connections. Communication interface 970 may permit device 900 to receive information from another device and/or provide information to another device. For example, communication interface 970 may include an Ethernet interface, an optical interface, a coaxial interface, an infrared interface, a radio frequency (RF) interface, a universal serial bus (USB) interface, a Wi-Fi interface, a cellular network interface, or the like.

Device 900 may perform one or more processes described herein. Device 900 may perform these processes in response to processor 920 executing software instructions stored by a non-transitory computer-readable medium, such as memory 930 and/or storage component 940. A computer-readable medium is defined herein as a non-transitory memory device. A memory device includes memory space within a single physical storage device or memory space spread across multiple physical storage devices.

Software instructions may be read into memory 930 and/or storage component 940 from another computer-readable medium or from another device via communication interface 970. When executed, software instructions stored in memory 930 and/or storage component 940 may cause processor 920 to perform one or more processes described herein.

Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 9 are provided as an example. In practice, device 900 may include additional components, fewer components, different components, or differently arranged components than those shown in FIG. 9. Additionally, or alternatively, a set of components (e.g., one or more components) of device 900 may perform one or more functions described as being performed by another set of components of device 900.

In embodiments, any one of the operations or processes of FIGS. 1 through 7 may be implemented by or using any one of the elements illustrated in FIGS. 8 and 9.

In accordance with example embodiments, a bulk export function integrated into a data view application utilizes a generic data fetching mechanism to fetch resource data from various resources (e.g., columns of tables). As a result, the export function may be generically used to bulk export resource data for any of plural views and for any configuration or modification of a view, thereby eliminating the required development and attendant user inconvenience and time to configure customized APIs and mechanisms by which resource data is fetched and exported.

The foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

What is claimed is:

1. A system for bulk exporting resource data of parameters included in a view, the system comprising:
at least one memory storing instructions; and
at least one processor configured to execute the instructions to:
receive a user request to bulk export resource data of the parameters for a plurality of instances of the view,
based on the received user request, obtain view details for the view, wherein the view details comprise identifiers of the parameters included in the view and identifiers of one or more tables in which the resource data of the parameters are respectively stored,
obtain, from the one or more tables and based on the view details, the resource data of the parameters for each of the plurality of instances of the view, and
generate an export file including headers with the identifiers of the parameters, based on the obtained view details, and the obtained resource data of the parameters.

2. The system as claimed in claim 1, wherein:
the at least one processor is further configured to execute the instructions to:
make, by a first application, a get data API call for fetching the resource data of the parameters included in the plurality of instances of the view configured by the first application, wherein an input of the get data API call comprises a view identifier corresponding to the view, and
obtain, in response to the get data API call, the view details for the view; and
the get data API is generic across a plurality of views including a plurality of different parameters.

3. The system as claimed in claim 1, wherein the at least one processor is further configured to execute the instructions to:
obtain, based on the identifiers the of one or more tables, information of a second application from resource information pre-registered in the first application, the resource information mapping applications to tables respectively associated with the applications; and
send a request to the second application for resource data of at least one parameter, among the parameters, stored in at least one table associated with the second application, from among the one or more tables.

4. The system as claimed in claim 1, wherein the at least one processor is further configured to execute the instructions to:
receive a first user input of one or more filters for selecting the view, the one or more filters including a common identifier for the plurality of instances of the view;
based on the received first user input, output a list of instances of the view that satisfy the one or more filters; and
receive a second user input for selecting the plurality of instances for which the resource data is to be bulk exported, from among the list of instances.

5. The system as claimed in claim 4, wherein the at least one processor is further configured to execute the instructions to verify that the selected plurality of instances correspond to a same view, based on a view name identifier included in metadata for each of the plurality of instances.

6. The system as claimed in claim 1, wherein the export file is a spreadsheet in which the headers are included in a top row and rows below the top row respectively include the resource data of the parameters for the plurality of instances, with each row associated with a corresponding instance of the view.

7. The system as claimed in claim 1, wherein the identifiers of the parameters are distinguished by different colors corresponding to a plurality of different types of the parameters determined from the view details, the plurality of different types comprising read-only, mandatory, and optional.

8. The system as claimed in claim 1, wherein the export file includes the obtained view details.

9. The system as claimed in claim 1, wherein the at least one processor is further configured to execute the instructions to update, based on the received user request, a status of plurality of instances of the view to complete.

10. A method, performed by at least one processor, for bulk exporting resource data of parameters included in a view, the method comprising:
receiving a user request to bulk export resource data of the parameters for a plurality of instances of the view;
based on the received user request, obtaining view details for the view, wherein the view details comprise identifiers of the parameters included in the view and identifiers of one or more tables in which the resource data of the parameters are respectively stored;
obtaining, from the one or more tables and based on the view details, the resource data of the parameters for each of the plurality of instances of the view; and
generating an export file including headers with the identifiers of the parameters, based on the obtained view details, and the obtained resource data of the parameters.

11. The method as claimed in claim 10, wherein:
the obtaining the view details comprises:
making, by a first application, a get data API call for fetching the resource data of the parameters included in the plurality of instances of the view configured by the first application, wherein an input of the get data API call comprises a view identifier corresponding to the view, and
obtaining, in response to the get data API call, the view details for the view; and
the get data API is generic across a plurality of views including a plurality of different parameters.

12. The method as claimed in claim 10, wherein the obtaining the resource data comprises:
obtaining, based on the identifiers the of one or more tables, information of a second application from resource information pre-registered in the first application, the resource information mapping applications to tables respectively associated with the applications; and
sending a request to the second application for resource data of at least one parameter, among the parameters, stored in at least one table associated with the second application, from among the one or more tables.

13. The method as claimed in claim 10, wherein the receiving the user request comprises:
receiving a first user input of one or more filters for selecting the view, the one or more filters including a common identifier for the plurality of instances of the view;
based on the received first user input, outputting a list of instances of the view that satisfy the one or more filters; and
receiving a second user input for selecting the plurality of instances for which the resource data is to be bulk exported, from among the list of instances.

14. The method as claimed in claim 13, further comprising verifying that the selected plurality of instances correspond to a same view, based on a view name identifier included in metadata for each of the plurality of instances.

15. The method as claimed in claim 10, wherein the export file is a spreadsheet in which the headers are included in a top row and rows below the top row respectively include the resource data of the parameters for the plurality of instances, with each row associated with a corresponding instance of the view.

16. The method as claimed in claim 10, wherein the identifiers of the parameters are distinguished by different colors corresponding to a plurality of different types of the parameters determined from the view details, the plurality of different types comprising read-only, mandatory, and optional.

17. The method as claimed in claim 10, wherein the export file includes the obtained view details.

18. The method as claimed in claim 10, further comprising updating, based on the received user request, a status of plurality of instances of the view to complete.

19. A non-transitory computer-readable recording medium having recorded thereon instructions executable by at least one processor to perform a method for bulk exporting resource data of parameters included in a view, the method comprising:
receiving a user request to bulk export resource data of the parameters for a plurality of instances of the view;
based on the received user request, obtaining view details for the view, wherein the view details comprise identifiers of the parameters included in the view and identifiers of one or more tables in which the resource data of the parameters are respectively stored;
obtaining, from the one or more tables and based on the view details, the resource data of the parameters for each of the plurality of instances of the view; and
generating an export file including headers with the identifiers of the parameters, based on the obtained view details, and the obtained resource data of the parameters.

20. The non-transitory computer-readable recording medium as claimed in claim 19, wherein:
the obtaining the view details comprises:
making, by a first application, a get data API call for fetching the resource data of the parameters included in the plurality of instances of the view configured by the first application, wherein an input of the get data API call comprises a view identifier corresponding to the view, and
obtaining, in response to the get data API call, the view details for the view; and
the get data API is generic across a plurality of views including a plurality of different parameters.
